(19) United States
(12) Patent Application Publication
(10) Pub. No.: US 2013/0233782 A1
(43) Pub. Date: Sep. 12, 2013

(54) ATOMIZING SPRAY HEADS, ATOMIZING METHODS, AND FLUID SYSTEMS OPERATING THEREWITH

(71) Applicants: Bruce Allen Eppink, Sylvania, OH (US); Frederick David Morrison, JR., Sylvania, OH (US)

(72) Inventors: Bruce Allen Eppink, Sylvania, OH (US); Frederick David Morrison, JR., Sylvania, OH (US)

(73) Assignee: BLISSFIELD MANUFACTURING COMPANY, Blissfield, MI (US)

(21) Appl. No.: 13/602,793

(22) Filed: Sep. 4, 2012

Related U.S. Application Data
(60) Provisional application No. 61/530,566, filed on Sep. 2, 2011.

(51) Int. Cl. B05B 17/04; B05B 1/26

(52) U.S. Cl. CPC B05B 17/04; B05B 1/265
USPC 210/209; 239/506; 239/520; 239/514; 239/11; 210/620

(57) ABSTRACT

An atomizing spray head suitable for delivering an atomized spray of a fluid with reduced blockage within the spray head. The spray head includes an inlet having a passage therein, a female tapered seat fluidically coupled to the passage of the inlet, and a male tapered plunger seated against the female tapered seat. The male tapered plunger is adjustably biased against the female tapered seat to pressurize a fluid that flows into the passage and causes the male tapered plunger to be unseated from the female tapered seat. A window circumferentially surrounds the male tapered plunger, through which a pressurizing fluid that unseats the male tapered plunger from the female tapered seat is able to exit the spray head as an atomized spray in radial directions relative to the male tapered plunger.

### CROSS REFERENCE TO RELATED APPLICATIONS

This application claims the benefit of U.S. Provisional Application No. 61/530,566, filed Sep. 02, 2011, the contents of which are incorporated herein by reference.

### BACKGROUND OF THE INVENTION

The present invention generally relates to fluid treatment apparatuses, and more particularly to spray heads capable of delivering an atomized spray of a fluid so that, for example, the fluid is able to absorb a second fluid.

Spray heads are generally devices adapted to disperse fluids in a spray containing droplets of the fluid. Spray heads are used for many purposes such as distributing a fluid over an area, increasing liquid surface area, and creating impact force on a solid surface. Generally, as fluid pressure increases, flow through the spray head increases, and droplet size decreases. Many configurations of spray heads are used depending on the spray characteristics desired.

Systems are known for pumping a fluid through a spray head to atomize the fluid so that the fluid is able to absorb a second fluid. One such example is a spray head adapted to introduce an atomized fluid (for example, potable water or sewage water) into a chamber containing oxygen at a high pressure, with the result that the fluid becomes saturated with oxygen. The oxygen-saturated fluid can then be introduced into a source of wastewater with the result that the wastewater contains sufficiently high levels of oxygen to promote the activity of aerobic microorganisms capable of biodegrading waste in the wastewater.

Current atomizing spray heads have a variety of designs. Typically, the atomizing spray heads include a tube with one or more orifices on an end of the tube and a deflector adjacent to the orifices. Pressurized fluid is pumped through the tube of the spray head, exiting the orifices, and contacting the deflector thereby atomizing the fluid. If the fluid contains solids, the tube may become blocked and flow restricted, requiring the spray head to be cleaned or replaced.

One method of reducing blockage within an atomizing head is to provide means by which the orifice size increases in response to blockage. As a nonlimiting example, an atomizing spray head may include a tapered screw and spring that cooperate such that, as fluid is pumped through the tube, contaminants trapped in the orifice build pressure upstream, causing the spring to expand, which in turn moves the screw to increase the size of the orifice such that the contaminants are able to pass through the orifice and out of the spray head. However, contaminants may catch on the internal spring itself, thereby blocking flow within the spray head.

Another method of reducing blockage within an atomizing spray head is to increase the cross-sectional area of the orifice and form the deflector in a spiral shape. The enlarged orifice reduces the likelihood of contaminants blocking the flow of the fluid, but may produce a less uniform spray pattern and density.

In view of the above, it can be appreciated that improved spray heads are desirable that are capable atomizing a fluid and reduce blockage while maintaining a desirable spray pattern and density.

### BRIEF DESCRIPTION OF THE INVENTION

The present invention provides an atomizing spray heads, atomizing methods, and systems using such heads and methods to deliver an atomized fluid spray.

According to a first aspect of the invention, an atomizing spray head includes an inlet having a passage therein, a female tapered seat fluidically coupled to the passage of the inlet, and a male tapered plunger seated against the female tapered seat. The male tapered plunger is adjustably biased against the female tapered seat to pressurize a fluid that flows into the passage and causes the male tapered plunger to be unseated from the female tapered seat. A window that circumferentially surrounds the male tapered plunger, through which a pressurizing fluid that unseats the male tapered plunger from the female tapered seat is able to exit the spray head as an atomized spray in radial directions relative to the male tapered plunger.

According to a second aspect of the invention, a method of atomizing a first fluid so that the first fluid is capable of absorbing a second fluid includes providing a spray head including an inlet having a passage therein, a female tapered seat fluidically coupled to the passage of the inlet, a male tapered plunger seated against the female tapered seat, and a window that circumferentially surrounds the male tapered plunger. The male tapered plunger is adjustably biased against the female tapered seat to pressurize a fluid that flows into the passage and causes the male tapered plunger to be unseated from the female tapered seat. The method further includes pumping a first fluid into the passage of the spray head through the inlet, pressurizing the first fluid that flows into the passage to cause the male tapered plunger to be unseated from the female tapered seat, and releasing the first fluid through the window of the spray head as an atomized spray in radial directions relative to the male tapered plunger.

According to a third aspect of the invention, a system for treating wastewater includes a spray head including inlet having a passage therein, a female tapered seat fluidically coupled to the passage of the inlet, and a male tapered plunger seated against the female tapered seat. The male tapered plunger is adjustably biased against the female tapered seat to pressurize a fluid that flows into the passage and causes the male tapered plunger to be unseated from the female tapered seat. A window that circumferentially surrounds the male tapered plunger, through which a pressurizing fluid that unseats the male tapered plunger from the female tapered seat is able to exit the spray head as an atomized spray in radial directions relative to the male tapered plunger. The system is adapted to deliver water to the spray head where the water is atomized with the atomizing spray head to produce an atomized spray and adapted to introduce the water atomized by the atomizing spray head into a source of wastewater to biodegrade waste in the wastewater by promoting the activity of aerobic microorganisms.

A technical effect of the invention is the ability to atomize a fluid and reduce blockage while maintaining a desirable spray pattern and density. In particular, the invention utilizes a biasing means adapted to allow contaminants to pass through the spray head without the contaminants interfering with the function of the biasing means.

Other aspects and advantages of this invention will be better appreciated from the following detailed description.

### BRIEF DESCRIPTION OF THE DRAWINGS

FIG. 1 is a side view representing an atomizing spray head in accordance with an aspect of this invention.

FIG. 2 represents a cross-sectional view of the atomizing spray head of FIG. 1 along section line B-B.

FIG. 3 is an end view of the atomizing spray head of FIG. 1.

FIG. 4 is an exploded view representing the atomizing spray head of FIG. 1.

FIG. 5 is a schematic representing a wastewater treatment system in accordance with an aspect of this invention.

### DETAILED DESCRIPTION OF THE INVENTION

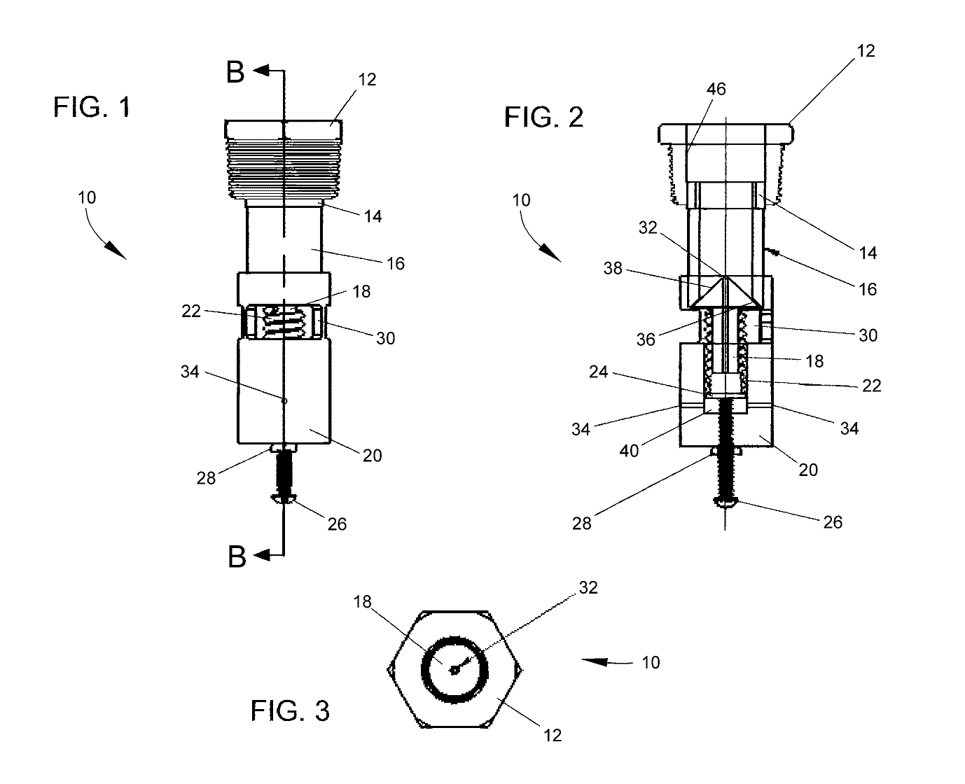

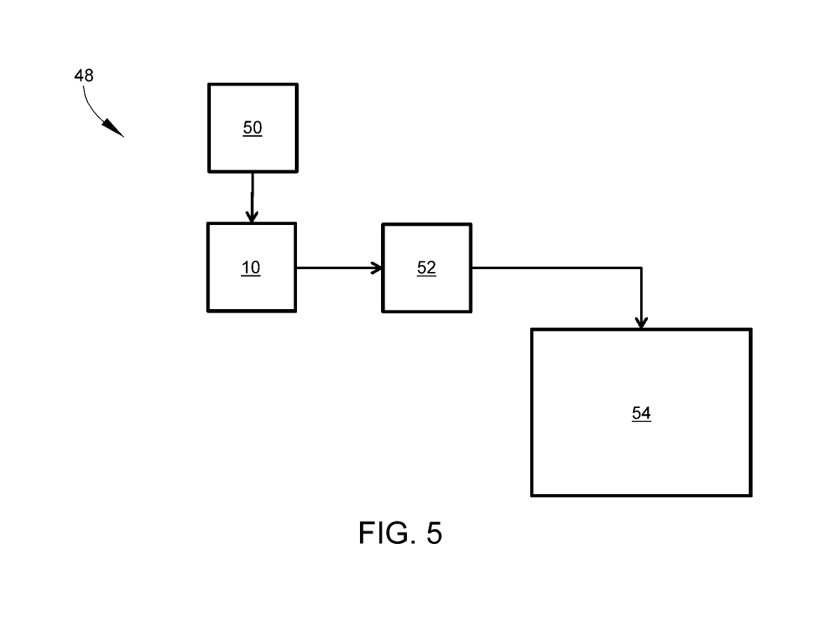

FIGS. 1 through 4 represent an atomizing spray head 10 that is capable of atomizing a fluid so that the fluid is capable of absorbing a second fluid. A preferred use of the spray head 10 is in a system 48 intended to treat wastewater, such as represented in FIG. 5. In such a system 48, the spray head 10 can be used to atomize water within a chamber or vessel 52 that contains a pressurized gas (as nonlimiting examples, oxygen, nitrogen, ozone (O₃), air, and mixtures thereof) for the purpose of supersaturating the water with the gas. The supersaturated water can then be introduced into a source of wastewater to biodegrade waste in the wastewater by promoting the activity of aerobic microorganisms. Other uses of the spray head 10 are also possible and within the scope of this invention.

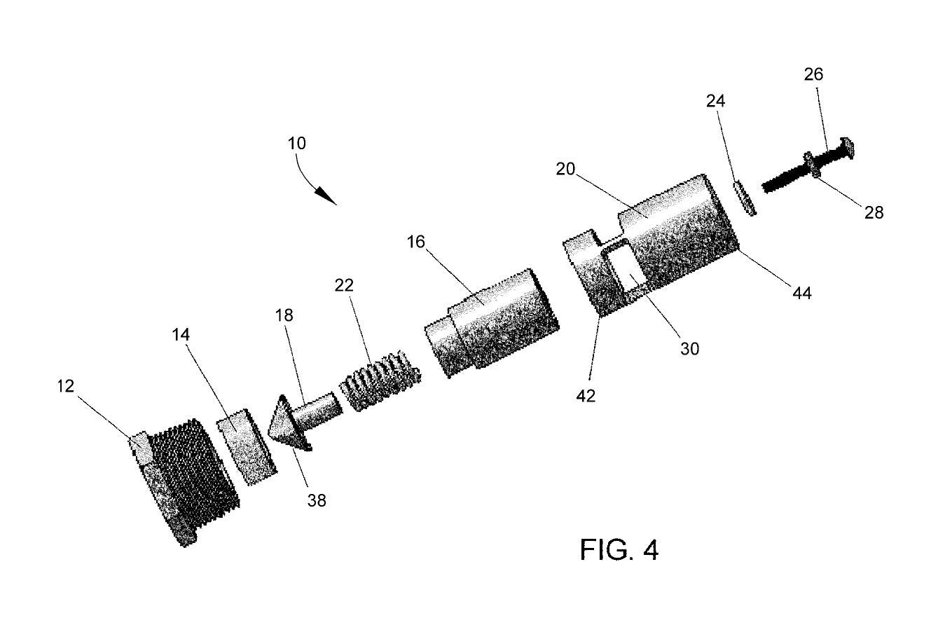

FIGS. 1, 2 and 3 represent side, cross-sectional and end views of the spray head 10, respectively, and FIG. 4 is an exploded view of the spray head 10. As labeled in FIGS. 1 through 4, the spray head 10 is an assembly comprising an inlet fitting 12, a bushing 14, an extension 16 that defines a female seat 36, a plunger 18 having a head 38 for engaging the female seat 36, and a housing 20 that defines a pocket 40 containing a stem portion of the plunger 18 opposite the plunger head 38. The pocket 40 of the housing 20 is represented as further containing a compression coil spring 22 and thrust washer 24 assembled on the plunger 18. The housing 20 is equipped with an adjustment screw 26 and lock nut 28 by which the axial movement of the plunger 18 within the pocket 40 can be adjusted. The female tapered seat 36 and housing 20 are axially spaced apart from each other to define a spray window 30 that circumferentially surrounds the plunger head 38. FIGS. 1, 2 and 3 further represent the spray head 10 as comprising a pass-through hole 32 within the plunger 18 that fluidically connects oppositely-disposed surfaces of the plunger 18 defined by the plunger head 38 and stem portion. A vent hole 34 is defined in the housing 20 for venting the pocket 40. The fitting 12 defines an inlet passage 46 that is coaxially aligned with the female seat 36, the plunger 18 and its head 38, and the spring 22. The female seat 36 and plunger head 38 are preferably complementarity tapered, as evident from FIG. 2. As a result, fluid flow to the plunger head 38 is axial, but fluid exits the window 30 of the spray head 10 in radial directions away from the plunger head 38.

The fitting 12 is assembled to the bushing 14 and extension 16 to form a subassembly. The plunger 18, spring 22 and washer 24 are placed within the spring pocket 40 and secured by inserting one end 42 of the housing 20 into the extension 16, causing the tapered head 38 of the plunger 18 to engage the tapered seat 36 and the plunger 18 to compress the spring 22. The screw 26 (with its lock nut 28) is threaded into a threaded bore in the opposite end 44 of the housing 20.

A fluid entering the spray head 10 through the passage 46 within the fitting 12 is pressurized against the plunger 18, resulting in the plunger head 38 being unseated from the tapered seat 36 to allow the fluid to exit the spray head 10 through the window 30 as an atomized spray. The screw 28 can be adjusted and locked into place to adjust the compression of the spring 22, which in turn adjusts the pressure required to unseat the plunger 18. Preferably, the fluid is atomized in a manner so that the fluid is capable of absorbing a second fluid. For example, it is believed that the atomized spray created by the spray head 10 includes both a fine mist and droplets of the fluid. The mist increases the surface area of the fluid increasing the likelihood that the fluid will absorb the second fluid, thereby increasing the likelihood that the fluid will become supersaturated.

The atomizing spray head 10 of FIGS. 1 through 4 is capable of providing various benefits and advantages relating to the control of the atomized fluid spray to produce a desired level of gas saturation. The atomized spray created by the spray head 10 contains aeration bubbles whose size is controlled by pressure and the flow rate of the fluid between the tapered seat 36 and plunger head 38. The pattern of the atomized spray can be adjusted with the screw 26 to adjust pressure against the plunger 18.

The spray head 10 has a self-cleaning capability as a result of the spring 22 allowing the plunger 18 to further retract into the housing 20 if pressure builds up due to contaminants restricting or blocking the fluid flow between the tapered seat 36 and plunger head 38, thereby allowing the build-up of contaminants to pass between the seat 36 and head 38. Further, since the spring 22 is enclosed in the housing 20 and external to the fluid flow, contaminants are less likely to interfere with the function of the spring 22.

In a similar manner, the spray head 10 has a self-adjusting capability to maintain a desired flow rate. The pass-through hole 32 in the plunger 18 is adapted to maintain a more optimal pressure balance across the plunger 18. The vent hole 34 of the housing 20 vents the spring pocket 40, and is thereby adapted to eliminate a hydraulic condition that might occur if the plunger 18 were to be fully retracted into the housing 20.

As mentioned previously, a notable use of the spray head 10 is in a system 48 intended to treat wastewater, as represented in FIG. 5. The wastewater treatment system 48 is shown in FIG. 5 as comprising a wastewater source 54 fluidically coupled to the spray head 10 and aforementioned pump 50 and vessel 52. The pump 50 delivers water (or another suitable liquid) to the spray head 10 resulting in an atomized spray. The atomized spray is collected in the vessel 52 which may contain pressurized oxygen (or another suitable gas) for the purpose of supersaturating the water with the gas. The supersaturated water can then be introduced into the source of wastewater 54 to biodegrade waste in the wastewater by promoting the activity of aerobic microorganisms.

While the invention has been described in terms of a specific embodiment, it is apparent that other forms could be adopted by one skilled in the art. For example, the physical configuration of the spray head 10 and its components could differ from that shown, and materials and processes other than those noted could be used. Furthermore, while the spring 22 is shown as a compression coil spring, other types of springs, mechanical biasing means, and nonmechanical biasing means could be utilized to bias the plunger head 38 against the tapered seat 36. Therefore, the scope of the invention is to be limited only by the following claims.

1. An atomizing spray head comprising:
an inlet having a passage therein;
a female tapered seat fluidically coupled to the passage of the inlet;
a male tapered plunger seated against the female tapered seat;
means for biasing the male tapered plunger against the female tapered seat and pressurizing a fluid that flows into the passage to cause the male tapered plunger to be unseated from the female tapered seat; and
a window that circumferentially surrounds the male tapered plunger and through which a pressurizing fluid that unseats the male tapered plunger from the female tapered seat is able to exit the spray head as an atomized spray in radial directions relative to the male tapered plunger.

2. The atomizing spray head of claim 1, the spray head further comprising a pass-through hole in the male tapered plunger for maintaining a pressure balance between a pump that delivers the fluid to the spray head and a vessel into which the atomized spray is released.

3. The atomizing spray head of claim 1, the spray head further comprising:
a housing axially spaced from the female tapered seat to define the window therebetween; and
a pocket defined in the housing and in which a stem portion of the male tapered plunger is received for axial movement therein.

4. The atomizing spray head of claim 3, further comprising a vent hole that vents the pocket to eliminate a hydraulic condition that might occur if the male tapered plunger were to be fully retracted into the pocket.

5. The atomizing spray head of claim 1, wherein the biasing means is a spring.

6. The atomizing spray head of claim 5, wherein the spring is external to a path of a fluid flowing within the atomizing spray head.

7. The atomizing spray head of claim 5, wherein the spring is enclosed within a housing that is axially spaced from the female tapered seat to define the window therebetween.

8. A method of atomizing a first fluid so that the first fluid is capable of absorbing a second fluid using the atomizing spray head of claim 1, the method comprising:
pumping the first fluid into the spray head so that the first fluid enters the spray head through the passage within the inlet of the spray head causing the first fluid to be pressurized against the male tapered plunger and result in the male tapered plunger being unseated from the tapered seat to allow the first fluid to exit the spray head through the window as an atomized spray.

9. The method of claim 8, wherein the first fluid is water and the second fluid is a gas.

10. A method of treating wastewater using the atomizing spray head of claim 1, the method comprising:
pumping water into the inlet of the atomizing spray head;
atomizing the water with the atomizing spray head to produce an atomized spray; and
introducing the water atomized by the atomizing spray head into a source of wastewater to biodegrade waste in the wastewater by promoting the activity of aerobic microorganisms.

11. The method of claim 10, wherein the atomized spray is produced in a vessel containing a pressurized gas and the pressurized gas is absorbed by the water, such that the water contains the pressurized gas when introduced into the source of wastewater.

12. A method of atomizing a first fluid so that the first fluid is capable of absorbing a second fluid, the method comprising:
providing a spray head comprising an inlet having a passage therein, a female tapered seat fluidically coupled to the passage of the inlet, a male tapered plunger seated against the female tapered seat, means for biasing the male tapered plunger against the female tapered seat, and a window that circumferentially surrounds the male tapered plunger;
pumping a first fluid into the passage of the spray head through the inlet;
pressurizing the first fluid that flows into the passage to cause the male tapered plunger to be unseated from the female tapered seat; and
releasing the first fluid through the window of the spray head as an atomized spray in radial directions relative to the male tapered plunger.

13. The method of claim 12, further comprising maintaining a pressure balance between a pump that delivers the first fluid to the spray head and a vessel into which the atomized spray is released with a pass-through hole in the male tapered plunger of the spray head.

14. The method of claim 11, wherein the biasing means is enclosed within a housing that is axially spaced from the female tapered seat to define the window therebetween and a stem portion of the male tapered plunger is received in a pocket defined in the housing for axial movement therein, the method further comprising venting the pocket to eliminate a hydraulic condition that might occur if the male tapered plunger were to be fully retracted into the pocket.

15. The method of claim 11, wherein the biasing means of the spray head is a spring.

16. The method of claim 15, wherein the spring is external to a path of the first fluid flowing within the atomizing spray head.

17. The method of claim 15, wherein the spring is enclosed within a housing that is axially spaced from the female tapered seat to define the window therebetween.

18. A system for treating wastewater, the system comprising:
a spray head comprising an inlet having a passage therein, a female tapered seat fluidically coupled to the passage of the inlet, a male tapered plunger seated against the female tapered seat, means for biasing the male tapered plunger against the female tapered seat and pressurizing a fluid that flows into the passage to cause the male tapered plunger to be unseated from the female tapered seat, and a window that circumferentially surrounds the male tapered plunger and through which a pressurizing fluid that unseats the male tapered plunger from the female tapered seat is able to exit the spray head as an atomized spray in radial directions relative to the male tapered plunger;
means for delivering water to the spray head where the water is atomized with the atomizing spray head to produce an atomized spray; and
means for introducing the water atomized by the atomizing spray head into a source of wastewater to biodegrade waste in the wastewater by promoting the activity of aerobic microorganisms.

19. The system of claim 18, further comprising a vessel containing a pressurized gas and into which the atomized spray is introduced.

20. The system of claim 19, the spray head further comprising a pass-through hole in the male tapered plunger for maintaining a pressure balance between the delivering means and the vessel.

21. The system of claim 18, the spray head further comprising:
a housing axially spaced from the female tapered seat to define the window therebetween; and
a pocket defined in the housing and in which a stem portion of the male tapered plunger is received for axial movement therein.

22. The system of claim 21, further comprising a vent hole that vents the pocket to eliminate a hydraulic condition that might occur if the male tapered plunger were to be fully retracted into the pocket.

23. The system of claim 18, wherein the biasing means of the spray head is a spring.

24. The system of claim 22, wherein the spring is external to a path of water flowing within the atomizing spray head.

25. The system of claim 22, wherein the spring is enclosed within a housing that is axially spaced from the female tapered seat to define the window therebetween.
